(19) United States
(12) Patent Application Publication
(10) Pub. No.: US 2025/0258346 A1
(43) Pub. Date: Aug. 14, 2025

(54) HYBRID OPTIC WAVEGUIDE INPUT/OUTPUT (IO) AND ELECTRIC IO INTEGRATION FOR HIGH PERFORMANCE CHIPS

(71) Applicant: QUALCOMM Incorporated, San Diego, CA (US)

(72) Inventor: Xia LI, San Diego, CA (US)

(21) Appl. No.: 18/437,091

(22) Filed: Feb. 8, 2024

(51) Int. Cl. G02B 6/42

(52) U.S. Cl. CPC G02B 6/4206; G02B 6/42

(57) ABSTRACT

A chip is described, including a substrate having an active device in the substrate. The chip also includes a first optical waveguide on the substrate. The chip further includes a second optical waveguide on the first optical waveguide and extending from the first optical waveguide though back-end-of-line (BEOL) layers of the chip. The chip also includes a waveguide photo detector (PD) on the first optical waveguide and communicably coupled to the active device through the BEOL layers of the chip.

### BACKGROUND

### Field

The present disclosure relates to wireless communication systems, and more specifically, to a hybrid optic waveguide input/output (IO) and electric IO integration for high performance chips.

### Background

Electrical interconnections of active devices may exist at each level of a system hierarchy, ranging from the lowest system level to a highest system level. For example, interconnect layers may connect different devices together on an integrated circuit (IC). As ICs become more complex, more interconnect layers provide the electrical connections between the devices. More recently, the number of interconnect levels for circuitry has increased due to the substantial number of devices that are now interconnected in a modern electronic device. The increased number of interconnect levels for supporting the increased number of devices involves more intricate processes.

These interconnect layers may provide transmission line structures for interconnecting IC devices in high-speed computing designs. During operation, the speed and throughput/bandwidth (BW) of chips configured for high-speed computing is limited (e.g., 10˜20 gigabytes (GB)). As a result, chip performance is lower, and input/output (IO) power is higher due to the noted bandwidth limitation and the multiple IOs specified for moving data in the chip, which consume a significant amount of energy. An optic waveguide IO may solve the bandwidth limitation of these high-speed chip computing designs. Unfortunately, optic waveguide IOs are not available in these high-speed chip computing designs. A hybrid optic waveguide IO and electric IO integration for high performance chips is desired.

### SUMMARY

A chip is described, including a substrate having an active device in the substrate. The chip also includes a first optical waveguide on the substrate. The chip further includes a second optical waveguide on the first optical waveguide and extending from the first optical waveguide though back-end-of-line (BEOL) layers of the chip. The chip also includes a waveguide photo detector (PD) on the first optical waveguide and communicably coupled to the active device through the BEOL layers of the chip.

A method of fabricating a chip is described. The method includes forming an active device in a substrate. The method also includes forming a first optical waveguide on the substrate. The method further includes forming a second optical waveguide on the first optical waveguide, in which the second optical waveguide extends from the first optical waveguide though back-end-of-line (BEOL) layers of the chip. The method also includes forming a waveguide photo detector (PD) on the first optical waveguide and communicably coupled to the active device through the BEOL layers of the chip.

This has outlined, broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-chip (SOC), including an electrical path integrated with an optical waveguide to provide high bandwidth input/output (IO) communication, in accordance with certain aspects of the present disclosure.

FIGS. 2A and 2B illustrate top-down views of a hybrid optical waveguide and input/output (IO) chip integration, according to various aspects of the present disclosure.

FIG. 3 is a cross-sectional view illustrating the hybrid optical waveguide shown in FIG. 2A, according to various aspects of the present disclosure.

FIGS. 4A-4C are cross-sectional views illustrating the hybrid optical waveguide shown in FIG. 2A, according to various aspects of the present disclosure.

FIGS. 5A-5D are cross-sectional views further illustrating the hybrid optical waveguide shown in FIG. 2A, according to various aspects of the present disclosure.

FIGS. 6A-6D are cross-sectional views further illustrating the hybrid optical waveguide shown in FIG. 2A, according to various aspects of the present disclosure.

FIG. 7 is a process flow diagram illustrating a method for fabricating a hybrid optical waveguide, according to an aspect of the present disclosure.

FIG. 8 is a block diagram showing an exemplary wireless communications system in which a configuration of the disclosure may be advantageously employed.

FIG. 9 is a block diagram illustrating a design workstation used for circuit, layout, and logic design of a semiconductor component according to one configuration.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

As described herein, the use of the term “and/or” is intended to represent an “inclusive OR,” and the use of the term “or” is intended to represent an “exclusive OR.” As described herein, the term “exemplary” used throughout this description means “serving as an example, instance, or illustration,” and should not necessarily be construed as preferred or advantageous over other exemplary configurations. As described herein, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described herein, the term “proximate” used throughout this description means “adjacent, very near, next to, or close to.” As described herein, the term “on” used throughout this description means “directly on” in some configurations, and “indirectly on” in other configurations.

Electrical interconnections of active devices may exist at each level of a system hierarchy, ranging from the lowest system level to a highest system level. In particular, interconnect layers may connect different devices together on an integrated circuit (IC). As ICs become more complex, more interconnect layers provide the electrical connections between these devices. More recently, the number of interconnect levels for circuitry has increased due to the substantial number of devices that are now interconnected in modern mobile radio frequency (RF) devices. The increased number of interconnect levels for supporting the increased number of devices involves more intricate processes.

These interconnect layers may provide transmission line structures for interconnecting IC devices in high-speed computing designs. During operation, the speed and throughput/bandwidth (BW) of chips configured for high-speed computing is limited (e.g., 10˜20 gigabytes (GB)). As a result, chip performance is lower, and input/output (IO) power is higher due to the noted IO bandwidth limitation and the multiple IOs specified for moving data in the chip consumes a significant amount of energy. An optical waveguide, however, may solve the IO bandwidth limitation of these high-speed chip computing designs.

As described, a waveguide is a structure that guides waves (e.g., light waves, acoustic waves, etc.) by restricting the transmission of energy to one direction. Without the physical constraint of a waveguide, waves would expand into three-dimensional space and their intensities would decrease according to the inverse square law. Common types of waveguides include acoustic waveguides that direct sound, optical waveguides that direct light, and radio-frequency waveguides that direct electromagnetic waves other than light (e.g., radio waves). Unfortunately, optical waveguides are not available in these high-speed chip computing designs for providing IO communication. A hybrid optical waveguide and electric signal integration for high performance IO communication in a chip, such as a system-on-chip (SOC) or a chiplet, is desired.

Various aspects of the disclosure are directed to a hybrid optical waveguide and chip integration for high performance IO communication. The process flow for hybrid optical waveguide and SOC integration may include front-end-of-line (FEOL) processes, middle-of-line (MOL) processes, and back-end-of-line (BEOL) processes. It will be understood that the term “layer” includes film and is not to be construed as indicating a vertical or horizontal thickness unless otherwise stated. As described herein, the term “substrate” may refer to a substrate of a diced wafer or may refer to a substrate of a wafer that is not diced. Similarly, the terms “chip” and “die” may be used interchangeably unless such interchanging would tax credulity.

As described, the BEOL interconnect layers may refer to the conductive interconnect layers (e.g., metal one (M1), metal two (M2), metal three (M3), metal four (M4), etc.) for electrically coupling to FEOL active devices of an integrated circuit. The BEOL interconnect layers may electrically couple to MOL interconnect layers for, for example, connecting M1 to an oxide diffusion (OD) layer of an integrated circuit. A BEOL first via (V2) may connect M2 to M3 or others of the BEOL interconnect layers.

Various aspects of the present disclosure are directed to optical waveguide and electric signal integration for high performance input/output (IO) communication in a chip. In various aspects of the present disclosure, a chip includes a substrate, having an active device on the substrate. The chip also includes a first optical waveguide above the substrate. The chip further includes a second optical waveguide extending from the first optical waveguide though back-end-of-line (BEOL) layers of the IO chip. The chip also includes a waveguide photo detector (PD) on the first IO optical waveguide communicably coupled to the active device through the BEOL layers of the chip.

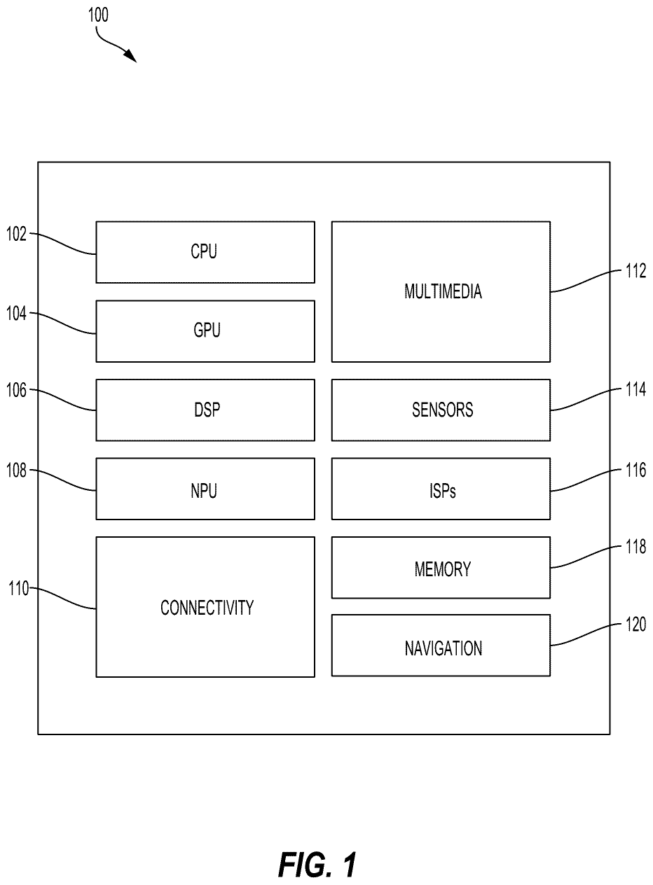

FIG. 1 illustrates an example implementation of a host system-on-chip (SOC) 100, including an electrical path integrated with an optical waveguide to provide high bandwidth input/output (IO) communication, in accordance with certain aspects of the present disclosure. The SOC 100 includes processing blocks tailored to specific functions, such as a connectivity block 110. The connectivity block 110 may include sixth generation (6G) connectivity, fifth generation (5G) new radio (NR) connectivity, fourth generation long term evolution (4G LTE) connectivity, Wi-Fi connectivity, USB connectivity, Bluetooth® connectivity, Secure Digital (SD) connectivity, and the like.

In this configuration, the SOC 100 includes various processing units that support multi-threaded operation. For the configuration shown in FIG. 1, the SOC 100 includes a multi-core central processing unit (CPU) 102, a graphics processor unit (GPU) 104, a digital signal processor (DSP) 106, and a neural processor unit (NPU) 108. The SOC 100 may also include a sensor processor 114, image signal processors (ISPs) 116, a navigation module 120, which may include a global positioning system (GPS), and a memory 118. The multi-core CPU 102, the GPU 104, the DSP 106, the NPU 108, and the multi-media engine 112 support various functions such as video, audio, graphics, gaming, artificial networks, and the like. Each processor core of the multi-core CPU 102 may be a reduced instruction set computing (RISC) machine, RISC-V, an advanced RISC machine (ARM), a microprocessor, or any reduced instruction set computing (RISC) architecture. The NPU 108 may be based on an ARM instruction set.

As noted, optical waveguides are not available in high-speed chip computing designs, such as the SOC 100, for providing input/output (IO) communication. During operation, the speed and throughput/bandwidth (BW) of the SOC 100 configured for high-speed computing is limited (e.g., 10˜20 GB). As a result, chip performance of the SOC 100 is lower and IO power is higher due to the noted IO bandwidth limitation and the multiple IOs specified for moving data in the SOC 100, which consume a significant amount of energy. An optical waveguide, however, may solve the IO bandwidth limitation of these high-speed chip computing designs.

As described, a waveguide is a structure that guides waves by restricting the transmission of energy to one direction. Without the physical constraint of a waveguide, waves would expand into three-dimensional space and their intensities would decrease according to the inverse square law. Common types of waveguides include acoustic waveguides that direct sound, optical waveguides that direct light, and radio-frequency waveguides that direct electromagnetic waves other than light (e.g., radio waves). Additionally, the geometry of a waveguide reflects its function. For example, in addition to more common types of waveguides that channel a wave in one dimension, there are two-dimensional slab waveguides that confine waves to two dimensions. The frequency of the transmitted wave also dictates the size of a waveguide. For example, each waveguide has a cutoff wavelength determined by its size and will not conduct waves of a greater wavelength. Commonly used waveguides are rectangular and circular in shape.

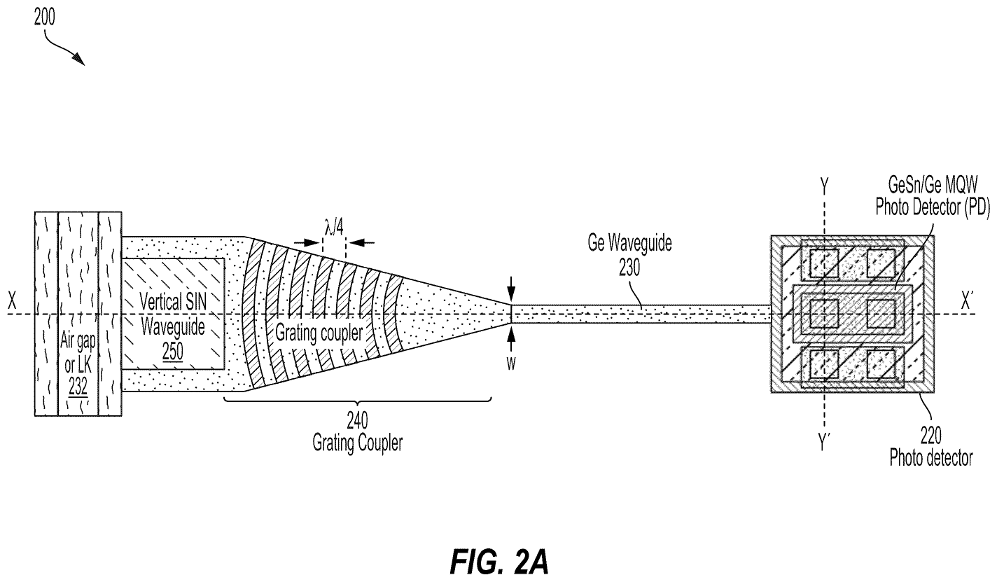

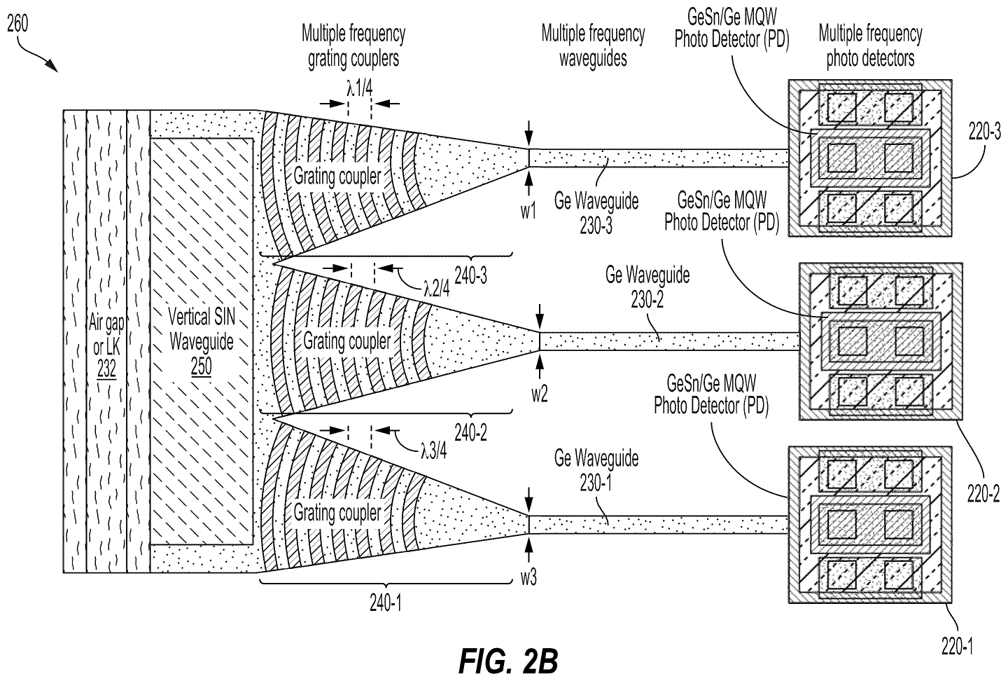

By contrast, optical waveguides are used at optical frequencies and may be dielectric waveguides, which are structures having a dielectric material with high permittivity, and thus high index of refraction, surrounded by a material with lower permittivity. The structure guides optical waves by total internal reflection. According to various aspects of the present disclosure, hybrid optical waveguide and electric signal integration for high performance IO communication in the SOC 100 is shown, for example, in FIGS. 2A and 2B.

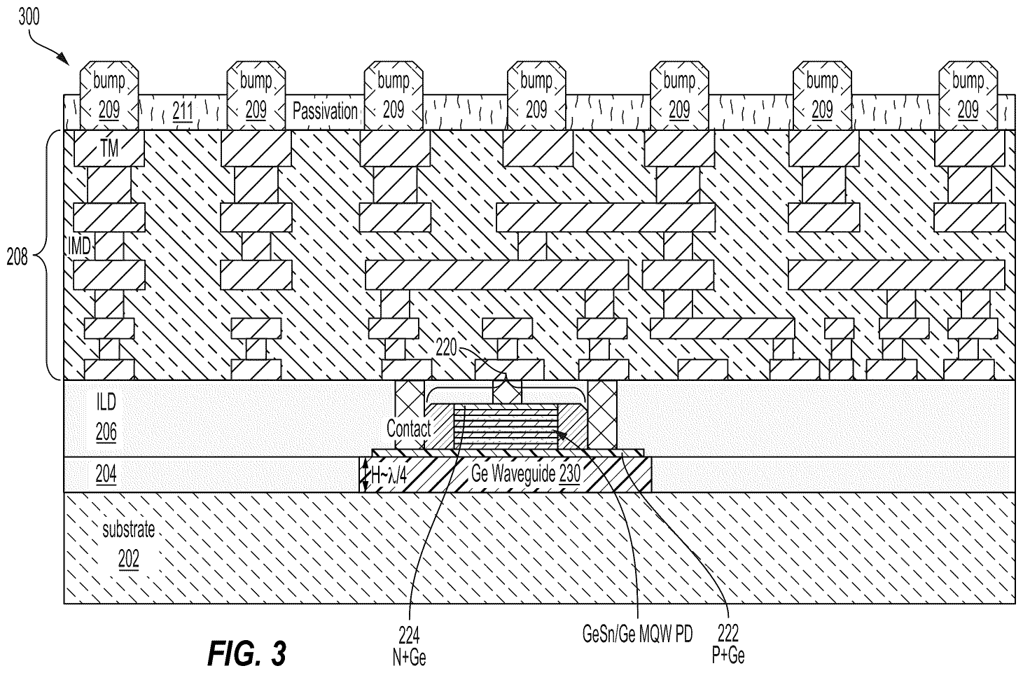

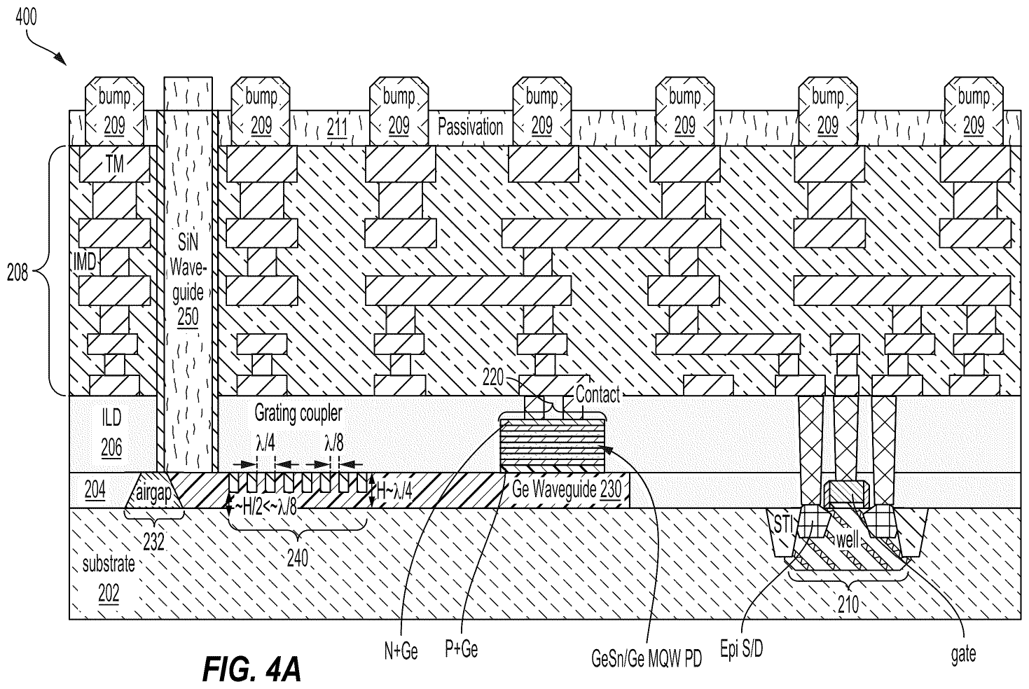

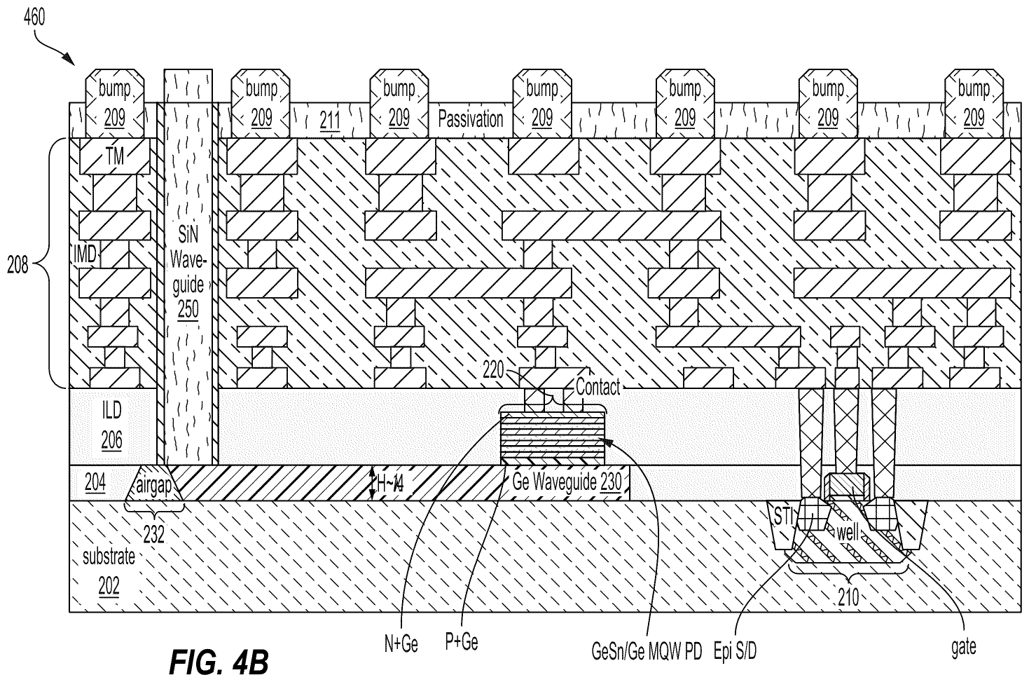

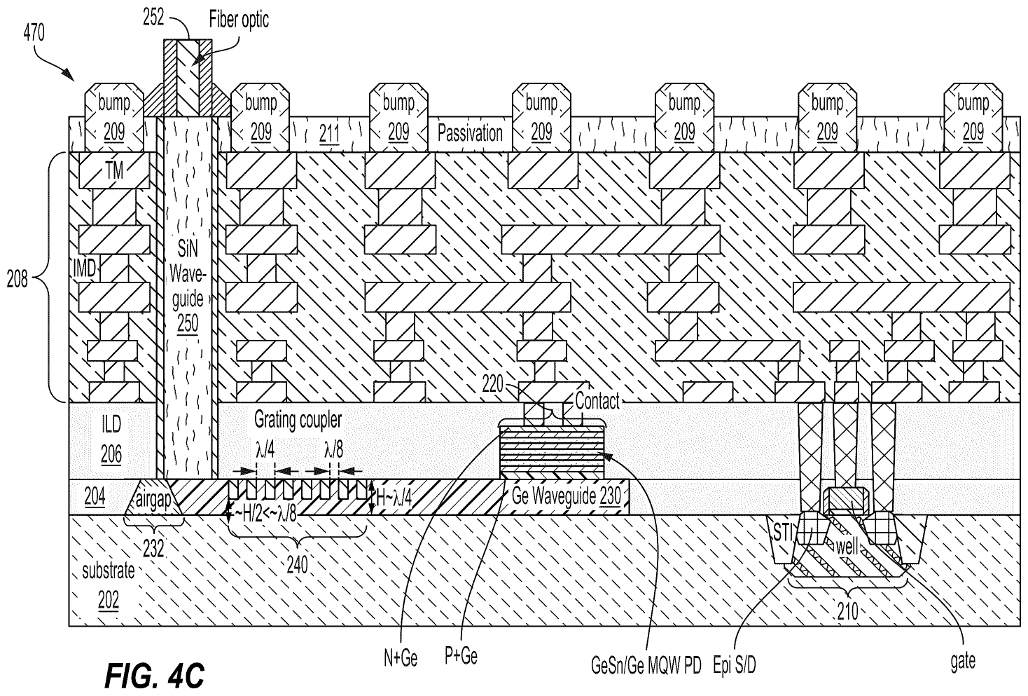

FIGS. 2A and 2B illustrate top-down views of a hybrid optical waveguide and input/output (IO) chip integration, according to various aspects of the present disclosure. FIG. 2A illustrates a top-down view of a hybrid optical waveguide 200, according to various aspects of the present disclosure. In this example, the hybrid optical waveguide 200 includes a first optical waveguide 230 above a substrate (not shown) and coupled to an airgap 232. Additionally, the hybrid optical waveguide 200 includes a second optical waveguide 250 extending from the first optical waveguide 230 though back-end-of-line (BEOL) layers of, for example, the SOC 100 of FIG. 1. The hybrid optical waveguide 200 includes a waveguide photo detector (PD) 220 on the first optical waveguide 230 and communicably coupled to an active device through the BEOL layers. In this example, the first optical waveguide 230 includes a grating coupler 240 (e.g., quarter (¼) wavelength (λ)) between the second optical waveguide 250 and the first optical waveguide 230. The hybrid optical waveguide 200 is further described in FIGS. 3-4C.

FIG. 2B illustrates a top-down view of a multi-frequency hybrid optical waveguide 260, according to various aspects of the present disclosure. In this example, the multi-frequency hybrid optical waveguide 260 includes multiple first optical waveguides 230 (230-1, 230-2, 230-3) above a substrate (not shown) and coupled to the airgap 232. Additionally, the multi-frequency hybrid optical waveguide 260 includes the second optical waveguide 250 extending from the multiple first optical waveguides 230 through BEOL layers of, for example, the SOC 100 of FIG. 1. The multi-frequency hybrid optical waveguide 260 includes multiple frequency waveguide photo detectors (PDs) 220 (220-1, 220-2, 220-3) on the first optical waveguides 230 and communicably coupled to active devices (not shown) through the BEOL layers. In this example, the first optical waveguides 230 include multiple grating couplers 240 (240-1 (e.g., λ¾), 240-2 (e.g., λ½), 240-3 (e.g., λ¼)) between the second optical waveguide 250 and the first optical waveguides 230.

FIG. 3 illustrates a cross-sectional view of the hybrid optical waveguide 200 of FIG. 2A, according to various aspects of the present disclosure. As shown in FIG. 3, a cross-sectional view 300 of the hybrid optical waveguide 200 is shown along the cutline YY′, extending crosswise, through the waveguide PD 220. In this example, the first optical waveguide 230 of the hybrid optical waveguide 200 is shown directly on a bulk semiconductor (e.g., silicon (Si)) substrate 202 in an interlayer dielectric (ILD) layer 204 directly on the substrate 202. In this example, the first optical waveguide 230 includes a first dopped layer 222 (e.g., a P+ germanium (Ge) layer) supporting the waveguide PD 220. The first optical waveguide 230 may be composed of germanium (Ge), silicon germanium (SiGe), or other like semiconductor material. For example, the first optical waveguide 230 may be a Ge or Ge rib waveguide having a frequency of approximately fifteen (15) to two hundred (200) terahertz (THz).

In various aspects of the present disclosure, the waveguide PD 220 is a multiple quantum well (MQW) PD formed in an interlayer dielectric (ILD) layer 206 on the ILD layer 204 of the substrate 202. In this example, the waveguide PD 220 includes a second dopped layer 224 (e.g., an N+Ge layer), and is composed of germanium (Ge) tin (GeSn), germanium (Ge), or other like semiconductor material. Additionally, metal to diffusion (MD) contacts to the first dopped layer 222 and the second dopped layer 224, and back-end-of-line (BEOL) layers 208 coupled to bumps 209 extending through an intermetal dielectric (IMD) layer, and a passivation layer 211, are shown. According to various aspects of the present disclosure, the waveguide PD 220 enables integration of an electric signal path from an active device coupled to the BEOL layers 208 with the first optical waveguide 230 and the second optical waveguide 250. As described, integration refers to the effective combination of electrical and optical signs in a single chip, for example, as further illustrated in FIGS. 4A-4C.

FIGS. 4A-4C illustrate cross-sectional views of the hybrid optical waveguide 200 of FIG. 2A, according to various aspects of the present disclosure. As shown in FIG. 4A, a cross-sectional view 400 of the hybrid optical waveguide 200 is shown along the cutline XX′, extending lengthwise, through the hybrid optical waveguide 200. In this example, the first optical waveguide 230 is shown directly on the substrate 202 in the ILD layer 204 directly on the substrate 202. Additionally, a second optical waveguide 250 is shown on and orthogonal to the first optical waveguide 230. In this example, the second optical waveguide 250 extends from the first optical waveguide 230 though BEOL layers 208 proximate the grating coupler 240 and the airgap 232.

In this example, the substrate 202 includes an active device 210 in the substrate 202 and coupled to the BEOL layers 208. Additionally, the waveguide PD 220 is on the first optical waveguide 230 and communicably coupled to the active device 210 through the BEOL layers 208. In various aspects of the present disclosure, the waveguide PD 220 converts an electric signal from the active device 210 through the BEOL layers 208 for optical communication through the first optical waveguide 230 and the second optical waveguide 250. In this example, the second optical waveguide 250 is composed of silicon nitride (SiN). Additionally, a height (H) of the first optical waveguide 230 (e.g., H˜λ/4) and a depth (e.g., ˜H/2<˜λ/8) of the grating coupler 240 are shown.

FIG. 4B shows a cross-sectional view 460 of the hybrid optical waveguide 200 of FIG. 2A without the grating coupler 240, according to various aspects of the present disclosure. Additionally, FIG. 4C shows a cross-sectional view 470 of the hybrid optical waveguide 200 of FIG. 2A, including a fiber optic connection 252 to the second optical waveguide 250, according to various aspects of the present disclosure.

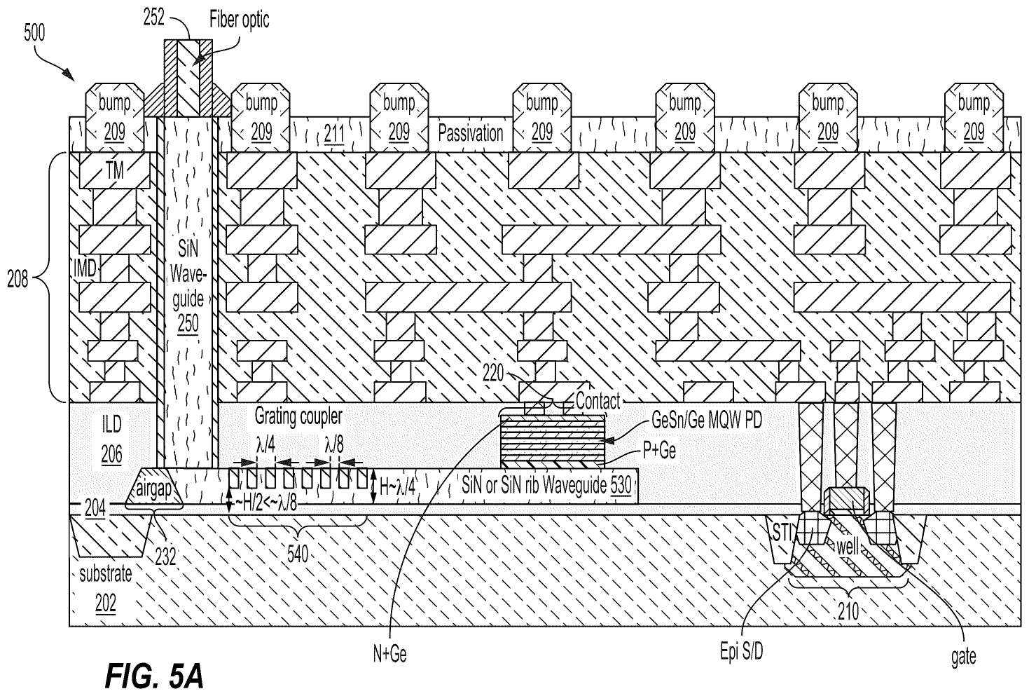

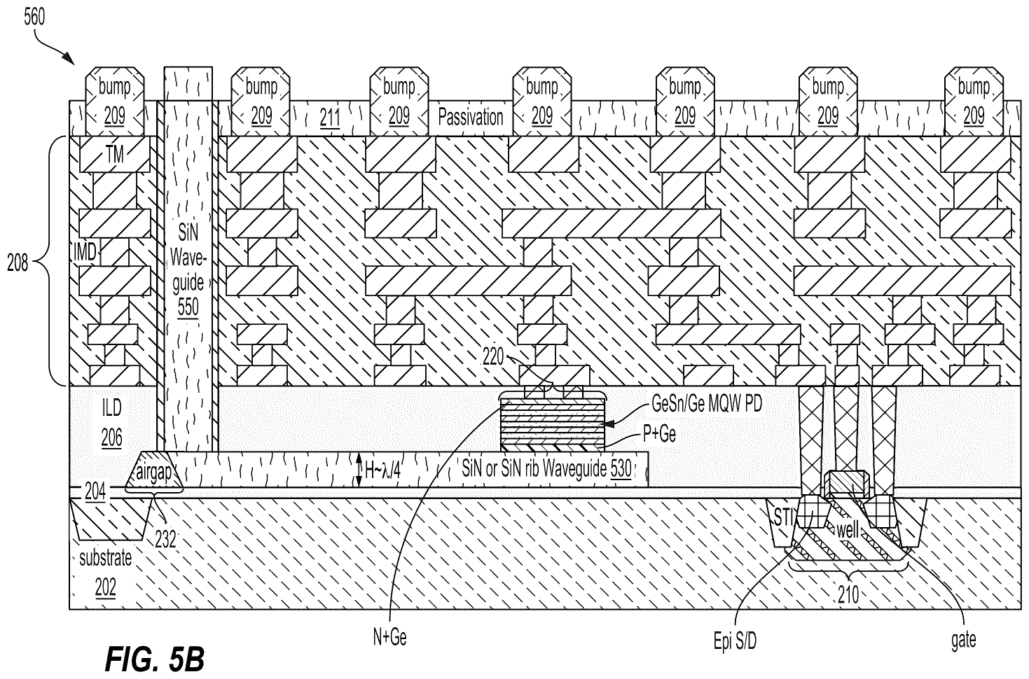

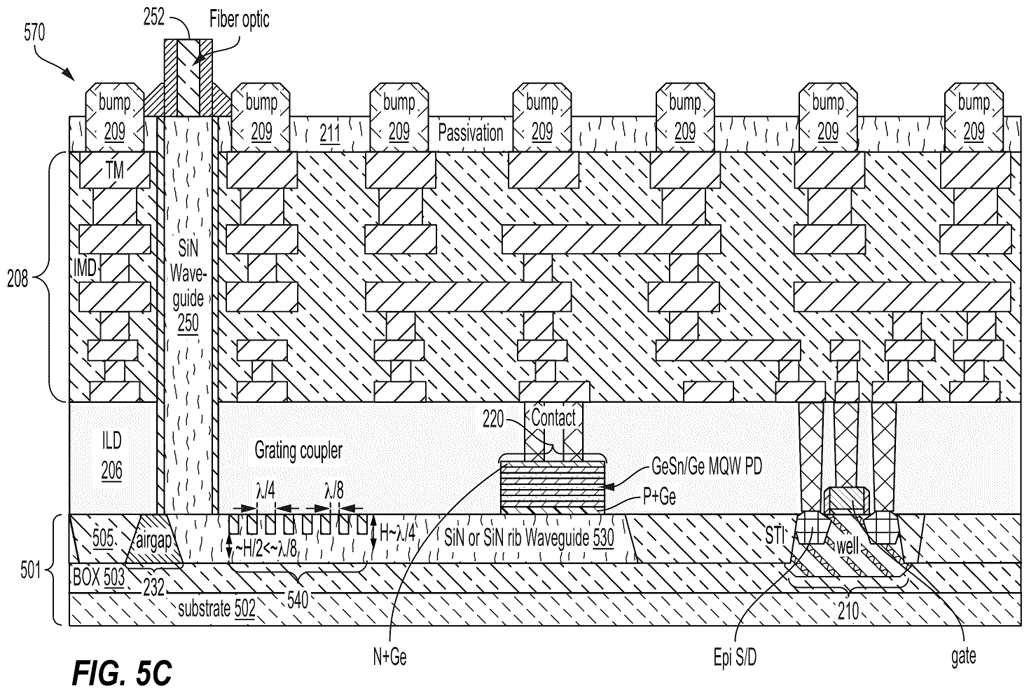

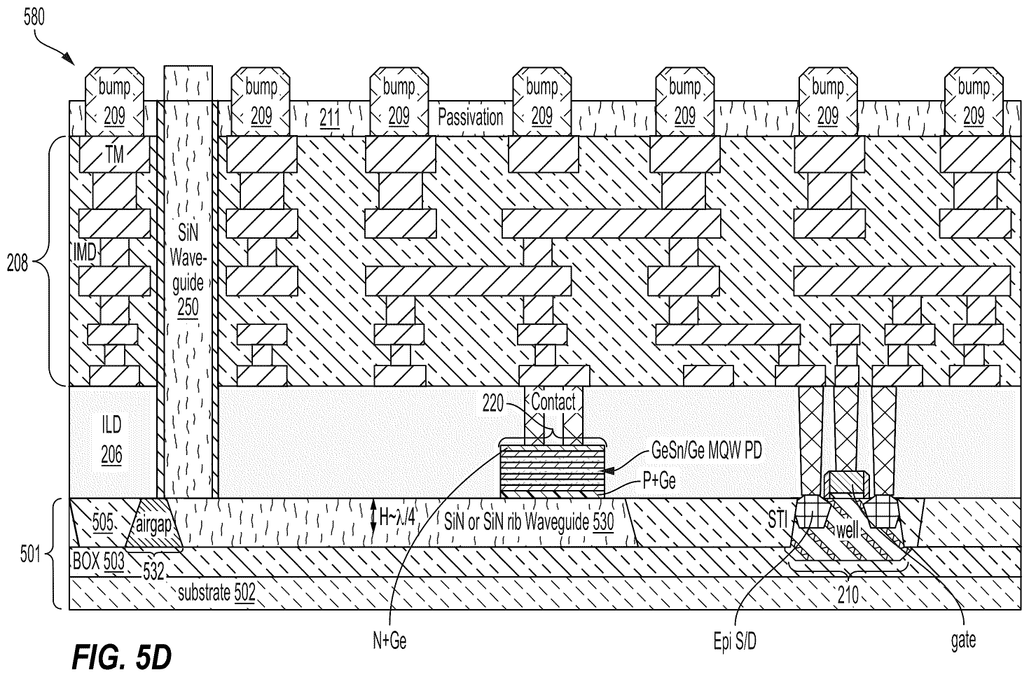

FIGS. 5A-5D illustrate cross-sectional views of variations of the hybrid optical waveguide 200 of FIG. 2A with common elements described using similar reference numbers, according to various aspects of the present disclosure. As shown in FIG. 5A, a cross-sectional view 500 of the hybrid optical waveguide 200 is shown along the cutline XX′, extending lengthwise, through the hybrid optical waveguide 200. In this example, a first optical waveguide 530 is shown directly on the ILD layer 204 directly on the substrate 202. Additionally, a grating coupler 540 is coupled between the second optical waveguide 250 and the first optical waveguide 530. In this example, the second optical waveguide 250 and the first optical waveguide 530 are composed of the same material (e.g., SiN), including the fiber optic connection 252 to the second optical waveguide 250.

FIG. 5B shows a cross-sectional view 560 of the hybrid optical waveguide 200 of FIG. 2A without the grating coupler 240, according to various aspects of the present disclosure. Additionally, FIG. 5C shows a cross-sectional view 570 of the hybrid optical waveguide 200 of FIG. 5A, including a semiconductor-on-insulator (SOI) substrate 501 and the fiber optic connection 252 to the second optical waveguide 250, according to various aspects of the present disclosure.

As shown in FIG. 5C, a silicon-on-insulator (SOI) substrate 501 includes a buried oxide (BOX) layer 503 on a substrate 502. The BOX layer 503 supports a silicon-on-insulator (SOI) layer 505 (e.g., silicon (Si)), which may be referred to as an active device layer. In this example, the first optical waveguide 530 and the grating coupler 540 as well as the active device 210 are formed in the SOI layer 505. FIG. 5D shows a cross-sectional view 580 of the hybrid optical waveguide 200 of FIG. 2A without the grating coupler 540 or a fiber optic connection 252 to the second optical waveguide 250, according to various aspects of the present disclosure.

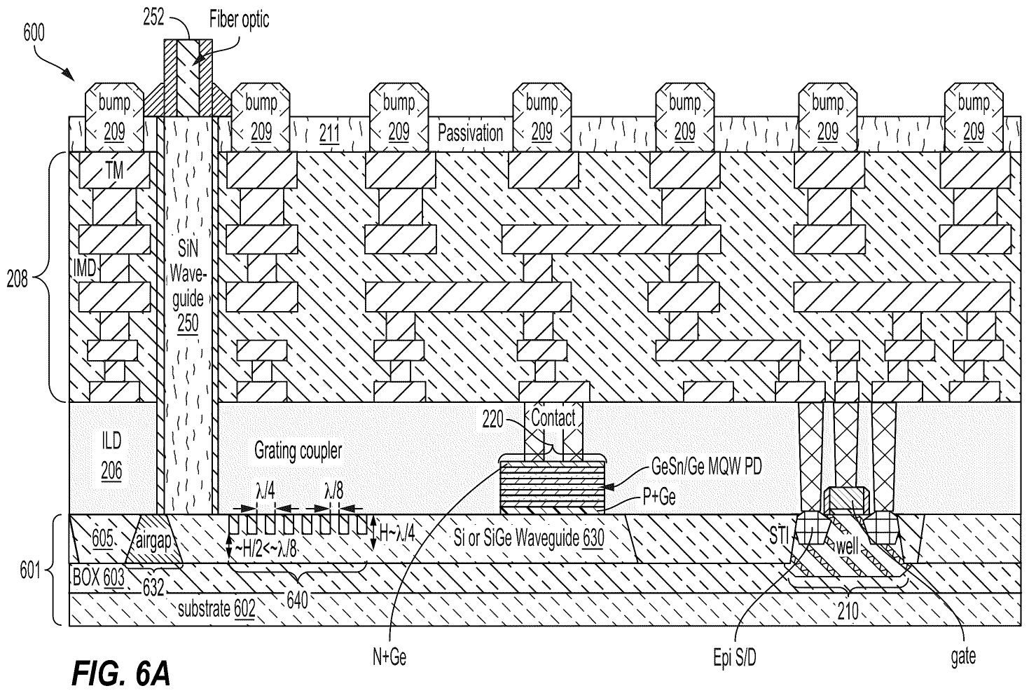

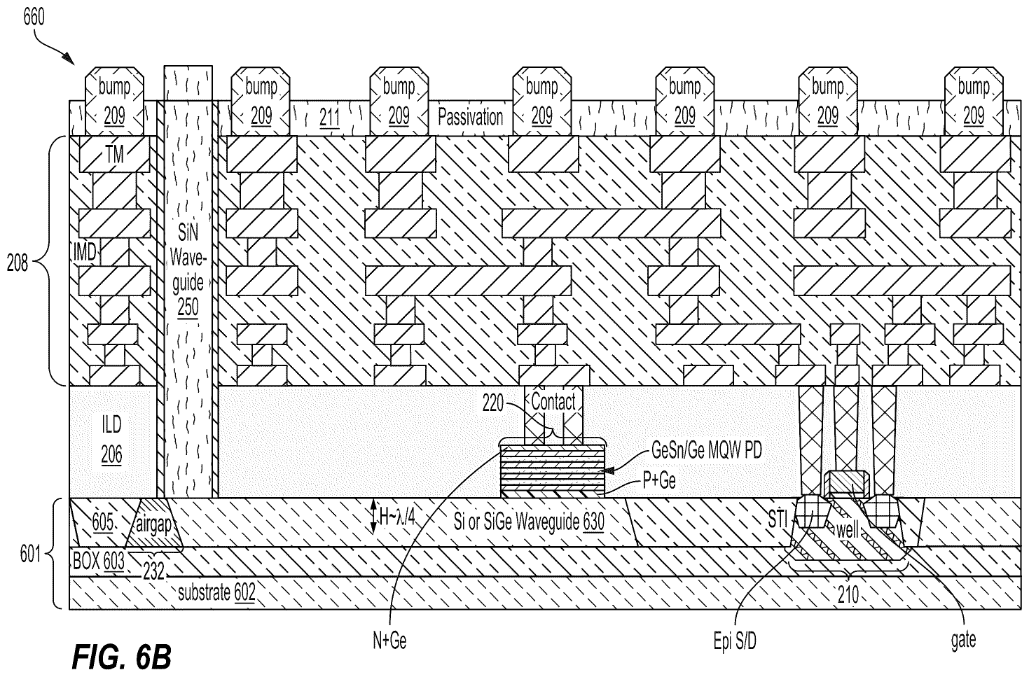

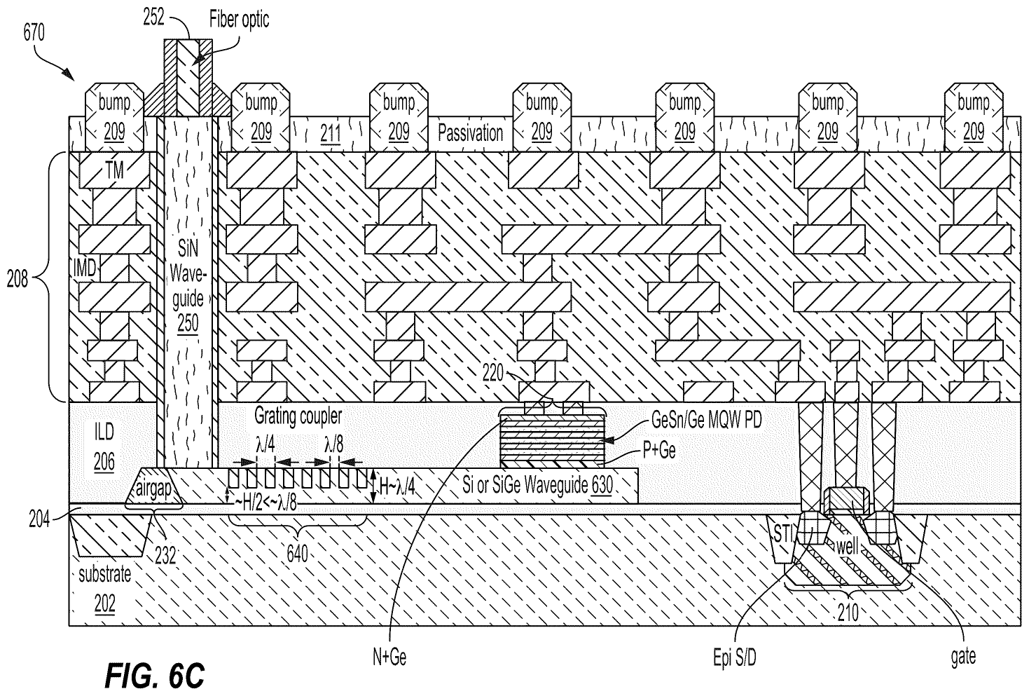

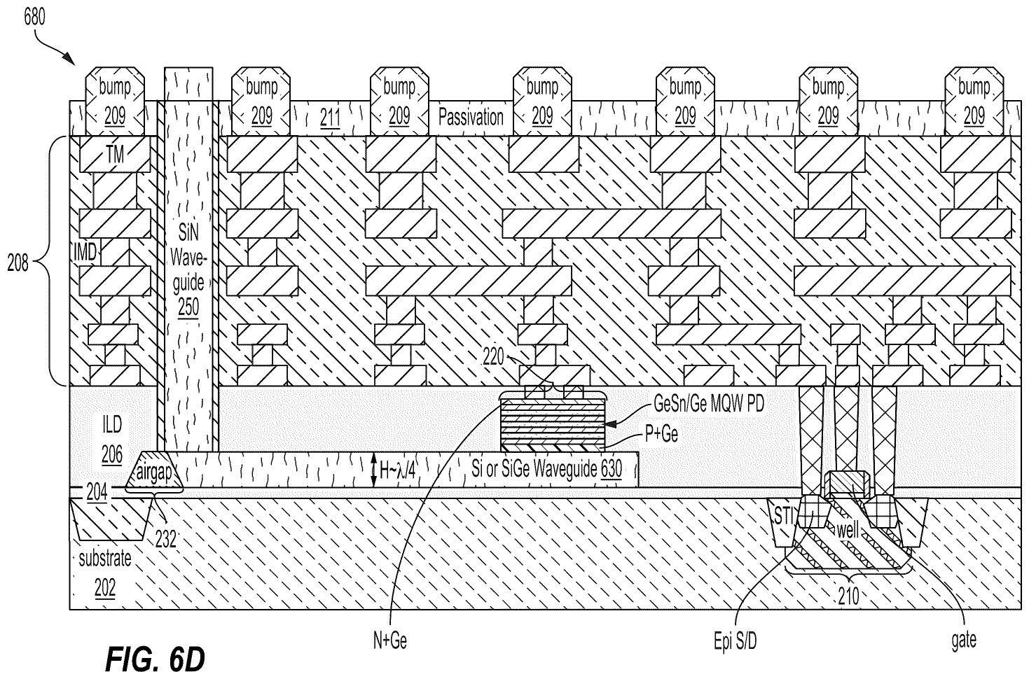

FIGS. 6A-6D illustrate cross-sectional views of variations of the hybrid optical waveguide 200 of FIG. 2A with common elements described using similar reference numbers, according to various aspects of the present disclosure. As shown in FIG. 6A, a cross-sectional view 600 of the hybrid optical waveguide 200 is shown along the cutline XX′, extending lengthwise, through the hybrid optical waveguide 200. In this example, a first optical waveguide 630 is formed in an SOI layer 605 of an SOI substrate 601, including a BOX layer 603 on a substrate 602. The BOX layer 603 supports the SOI layer 605. Additionally, a grating coupler 640 is coupled between the second optical waveguide 250 and the first optical waveguide 630. In this example, the first optical waveguide 630 is composed of a different material (e.g., Si or SiGe) than the second optical waveguide 250 (e.g., SiN), which includes the fiber optic connection 252 to the second optical waveguide 250.

FIG. 6B shows a cross-sectional view 660 of the hybrid optical waveguide 200 of FIG. 2A without the grating coupler 240, according to various aspects of the present disclosure. Additionally, FIG. 6C shows a cross-sectional view 670 of the hybrid optical waveguide 200 of FIG. 2A, including the first optical waveguide 630 and the grating coupler 640 formed on the ILD layer 204 on the substrate 202, including the fiber optic connection 252 to the second optical waveguide 250, according to various aspects of the present disclosure. FIG. 6D shows a cross-sectional view 680 of the hybrid optical waveguide 200 of FIG. 2A without the grating coupler 640 or a fiber optic connection 252 to the second optical waveguide 250, according to various aspects of the present disclosure.

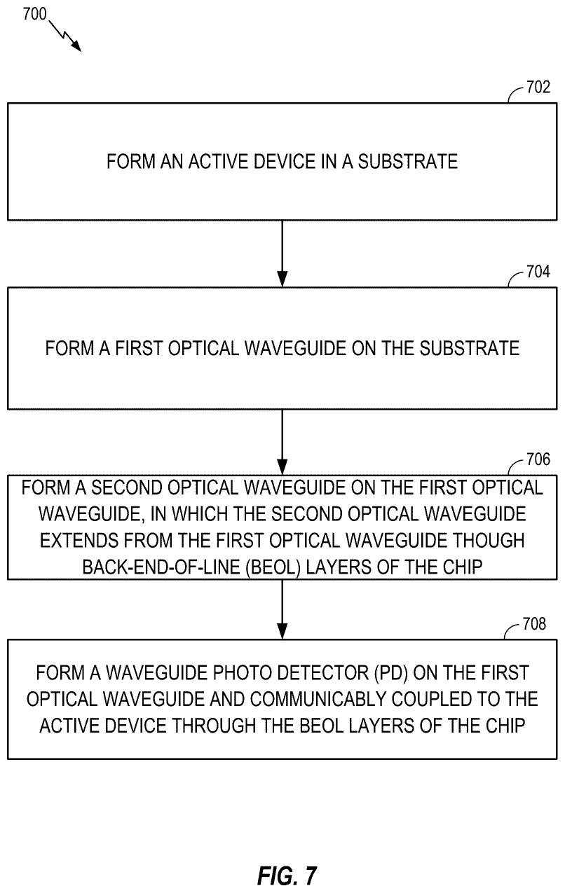

FIG. 7 is a process flow diagram illustrating a method of fabricating a chip, according to various aspects of the present disclosure. A method 700 begins at block 702, in which an active device is formed in a substrate. For example, as shown in FIG. 4A, the substrate 202 includes an active device 210 in the substrate 202 and coupled to the BEOL layers 208.

At block 704, a first optical waveguide is formed on the substrate. For example, as shown in FIG. 4A, the first optical waveguide 230 is shown directly on the substrate 202 in the ILD layer 204 directly on the substrate 202.

At block 706, a second optical waveguide is formed on the first optical waveguide, in which the second optical waveguide extends from the first optical waveguide though back-end-of-line (BEOL) layers of the chip. For example, as shown in FIG. 4A, a second optical waveguide 250 is shown on and orthogonal to the first optical waveguide 230. In this example, the second optical waveguide 250 extends from the first optical waveguide 230 though BEOL layers 208 proximate the grating coupler 240 and the airgap 232.

At block 708, a waveguide photo detector (PD) is formed on the first optical waveguide and communicably coupled to the active device through the BEOL layers of the chip. For example, as shown in FIGS. 2A and 4A, the hybrid optical waveguide 200 includes a waveguide photo detector (PD) 220 on the first optical waveguide 230 and communicably coupled to an active device through the BEOL layers.

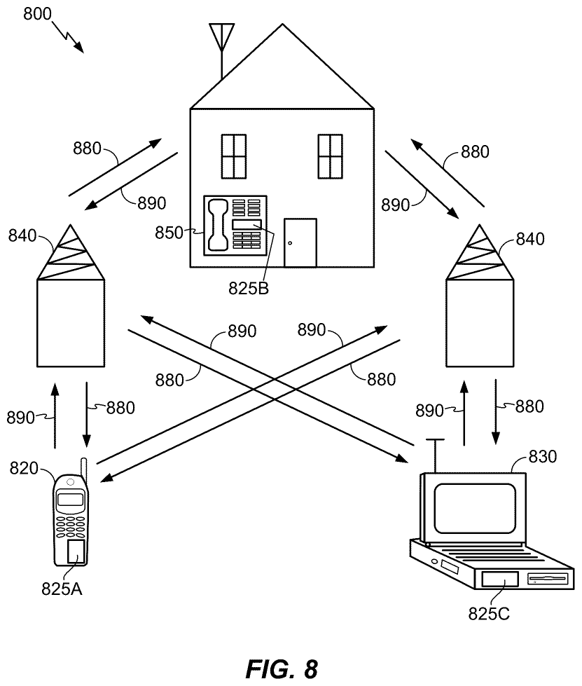

FIG. 8 is a block diagram showing an exemplary wireless communication system 800 in which an aspect of the disclosure may be advantageously employed. For purposes of illustration, FIG. 8 shows three remote units 820, 830, and 850 and two base stations 840. It will be recognized that wireless communication systems may have many more remote units and base stations. Remote units 820, 830, and 850 include IC devices 825A, 825C, and 825B that include the disclosed hybrid optical waveguide. It will be recognized that other devices may also include the disclosed hybrid optical waveguide, such as the base stations, switching devices, and network equipment. FIG. 8 shows forward link signals 880 from the base station 840 to the remote units 820, 830, and 850 and reverse link signals 890 from the remote units 820, 830, and 850 to base stations 840.

In FIG. 8, remote unit 820 is shown as a mobile telephone, remote unit 830 is shown as a portable computer, and remote unit 850 is shown as a fixed location remote unit in a wireless local loop system. For example, the remote units may be a mobile phone, a hand-held personal communication systems (PCS) unit, a portable data unit, such as a personal data assistant, a GPS enabled device, a navigation device, a set top box, a music player, a video player, an entertainment unit, a fixed location data unit, such as a meter reading equipment, or other device that stores or retrieves data or computer instructions, or combinations thereof. Although FIG. 8 illustrates remote units according to the aspects of the disclosure, the disclosure is not limited to these exemplary illustrated units. Aspects of the disclosure may be suitably employed in many devices, which include the disclosed hybrid optical waveguide.

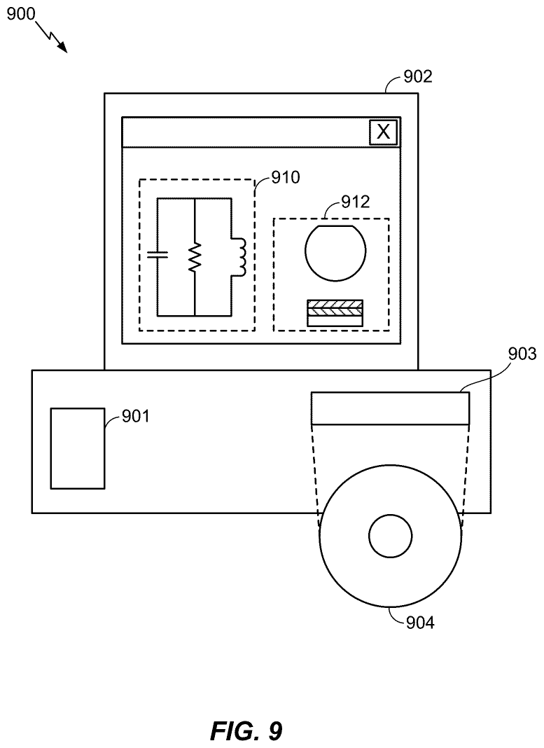

FIG. 9 is a block diagram illustrating a design workstation used for circuit, layout, and logic design of a semiconductor component, such as the hybrid optical waveguide disclosed above. A design workstation 900 includes a hard disk 901 containing operating system software, support files, and design software such as Cadence or OrCAD. The design workstation 900 also includes a display 902 to facilitate design of a circuit 910 or a hybrid optical waveguide 912. A storage medium 904 is provided for tangibly storing the design of the circuit 910 or the hybrid optical waveguide 912. The design of the circuit 910 or the hybrid optical waveguide 912 may be stored on the storage medium 904 in a file format such as GDSII or GERBER. The storage medium 904 may be a CD-ROM, DVD, hard disk, flash memory, or other appropriate device. Furthermore, the design workstation 900 includes a drive apparatus 903 for accepting input from or writing output to the storage medium 904.

Data recorded on the storage medium 904 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 904 facilitates the design of the circuit 910 or the hybrid optical waveguide 912 by decreasing the number of processes for designing semiconductor wafers.

Implementation examples are described in the following numbered clauses.

1. A chip, comprising:
a substrate including an active device in the substrate;
a first optical waveguide on the substrate;
a second optical waveguide on the first optical waveguide and extending from the first optical waveguide though back-end-of-line (BEOL) layers of the chip; and
a waveguide photo detector (PD) on the first optical waveguide and communicably coupled to the active device through the BEOL layers of the chip.

2. The chip of clause 1, in which the active device is coupled to the waveguide PD through the BEOL layers to integrate an electric signal path of the active device with the first optical waveguide and the second optical waveguide.

3. The chip of clause 1, in which the second optical waveguide is in an active device layer of the substrate and the waveguide PD is directly on the first optical waveguide.

4. The chip of clause 3, in which the active device layer comprises a silicon-on-insulator (SOI) layer.

5. The chip of any of clause 1-4, in which the waveguide PD comprises a multiple quantum well (MQW) PD.

6. The chip of any of clause 1-5, further comprising an airgap communicably coupled between the first optical waveguide and the second optical waveguide.

7. The chip of any of clause 1-5, further comprising a metal communicably coupled between the first optical waveguide and the second optical waveguide.

8. The chip of any of clause 1-7, further comprising a fiber optic cable coupled to the second optical waveguide.

9. The chip of any of clause 1-8, further comprising a grating coupler between the first optical waveguide and the second optical waveguide.

10. The chip of any of clause 1-9, in which the first optical waveguide and the second optical waveguide are composed of a same material.

11. The chip of clause 10, in which the same material comprises silicon nitride (SiN).

12. A method of fabricating a chip, comprising:
forming an active device in a substrate;
forming a first optical waveguide on the substrate;
forming a second optical waveguide on the first optical waveguide, in which the second optical waveguide extends from the first optical waveguide though back-end-of-line (BEOL) layers of the chip; and
forming a waveguide photo detector (PD) on the first optical waveguide and communicably coupled to the active device through the BEOL layers of the chip.

13. The method of clause 12, in which the active device is coupled to the waveguide PD through the BEOL layers to integrate an electric signal path of the active device with the first optical waveguide and the second optical waveguide.

14. The method of any of clause 12 or 13, in which the second optical waveguide is in an active device layer of the substrate and the waveguide PD is directly on the first optical waveguide.

15. The method of clause 14, in which the active device layer comprises a silicon-on-insulator (SOI) layer.

16. The method of any of clause 12-15, in which the waveguide PD comprises a multiple quantum well (MQW) PD.

17. The method of any of clause 12-16, further comprising forming an airgap communicably coupled between the first optical waveguide and the second optical waveguide.

18. The method of any of clause 12-16, further comprising forming a metal communicably coupled between the first optical waveguide and the second optical waveguide.

19. The method of any of clause 12-18, further comprising a fiber optic cable coupled to the second optical waveguide.

20. The method of any of clause 12-19, further comprising a grating coupler between the first optical waveguide and the second optical waveguide.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above, and below may refer to sides of a substrate or electronic device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform the same function or achieve the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store specified program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A chip, comprising:
a substrate including an active device in the substrate;
a first optical waveguide on the substrate;
a second optical waveguide on the first optical waveguide and extending from the first optical waveguide though back-end-of-line (BEOL) layers of the chip; and
a waveguide photo detector (PD) on the first optical waveguide and communicably coupled to the active device through the BEOL layers of the chip.

2. The chip of claim 1, in which the active device is coupled to the waveguide PD through the BEOL layers to integrate an electric signal path of the active device with the first optical waveguide and the second optical waveguide.

3. The chip of claim 1, in which the second optical waveguide is in an active device layer of the substrate and the waveguide PD is directly on the first optical waveguide.

4. The chip of claim 3, in which the active device layer comprises a silicon-on-insulator (SOI) layer.

5. The chip of claim 1, in which the waveguide PD comprises a multiple quantum well (MQW) PD.

6. The chip of claim 1, further comprising an airgap communicably coupled between the first optical waveguide and the second optical waveguide.

7. The chip of claim 1, further comprising a metal communicably coupled between the first optical waveguide and the second optical waveguide.

8. The chip of claim 1, further comprising a fiber optic cable coupled to the second optical waveguide.

9. The chip of claim 1, further comprising a grating coupler between the first optical waveguide and the second optical waveguide.

10. The chip of claim 1, in which the first optical waveguide and the second optical waveguide are composed of a same material.

11. The chip of claim 10, in which the same material comprises silicon nitride (SiN).

12. A method of fabricating a chip, comprising:
forming an active device in a substrate;
forming a first optical waveguide on the substrate;
forming a second optical waveguide on the first optical waveguide, in which the second optical waveguide extends from the first optical waveguide though back-end-of-line (BEOL) layers of the chip; and
forming a waveguide photo detector (PD) on the first optical waveguide and communicably coupled to the active device through the BEOL layers of the chip.

13. The method of claim 12, in which the active device is coupled to the waveguide PD through the BEOL layers to integrate an electric signal path of the active device with the first optical waveguide and the second optical waveguide.

14. The method of claim 12, in which the second optical waveguide is in an active device layer of the substrate and the waveguide PD is directly on the first optical waveguide.

15. The method of claim 14, in which the active device layer comprises a silicon-on-insulator (SOI) layer.

16. The method of claim 12, in which the waveguide PD comprises a multiple quantum well (MQW) PD.

17. The method of claim 12, further comprising forming an airgap communicably coupled between the first optical waveguide and the second optical waveguide.

18. The method of claim 12, further comprising forming a metal communicably coupled between the first optical waveguide and the second optical waveguide.

19. The method of claim 12, further comprising a fiber optic cable coupled to the second optical waveguide.

20. The method of claim 12, further comprising a grating coupler between the first optical waveguide and the second optical waveguide.
